(19) United States
(12) Patent Application Publication
(10) Pub. No.: US 2013/0283396 A1
(43) Pub. Date: Oct. 24, 2013

(54) SYSTEM AND METHOD FOR LIMITING EXECUTION OF SOFTWARE TO AUTHORIZED USERS

(71) Applicants: Nimrod Langer, Kibbutz Gesher Haziv (IL); Shlomit Pinter, Haifa (IL)

(72) Inventors: Nimrod Langer, Kibbutz Gesher Haziv (IL); Shlomit Pinter, Haifa (IL)

(73) Assignee: RASCALIM SOFTWARE SECURITY LTD., M.P. Hefer (IL)

(21) Appl. No.: 13/387,914

(22) PCT Filed: Jul. 26, 2010
(86) PCT No.: PCT/IL10/00593

§ 371 Date: May 1, 2013

Related U.S. Application Data
(60) Provisional application No. 61/229,720, filed on Jul. 30, 2009.

(51) Int. Cl. G06F 21/12

(52) U.S. Cl. CPC G06F 21/121
USPC 726/28

(57) ABSTRACT

The present invention relates to a method and system for protecting and limiting the execution of a software program only to an authorized user. The software program can be provided in any suitable software form, such as a binary code, or it can be written in a high level program language. In the present invention, the binary code of the program is analyzed and partitioned into parts, some of which are selected to be protected. The protected parts are selected so that during any execution of the software, at least some of the selected parts must be present and executed. The protected code is encrypted and at least partially saved on an attached secured computing device such as a secured disk on key with a small processor or controller, or a smart flash drive.

### FIELD OF THE INVENTION

The present invention relates to a method and system for securing software. Specifically, the present invention relates to a unique method and system for generating, distributing and executing software that is partially encrypted, where the encrypted parts are located and run on a trusted computing device. Examples of such computing devices include different types of mobile phones, PDAs, smart flash drives, video game consoles, GPS devices and other memory cards, including but not limited to, Secure Digital (SD Card), Secure Digital High-Speed, Secure Digital Plus/Xtra/etc. (SD with USB connector).

### BACKGROUND

The current invention addresses the problem of software piracy. The approach employed follows the Software Licensing Authentication Token (SLAT) solution, also known as the Digital Rights Management (DRM) solution.

Existing software security solutions on the market provide insufficient security and suffer from various deficiencies. Known typical hardware-based solutions, which use a dongle/key in conjunction with software are cumbersome and costly and can be easily removed since their integration is susceptible to simple attacks. Other software-based solutions are also less than optimal as they often require computer specialists for their implementation.

A comprehensive solution to address the software security problem should not only provide faultless security that is non-breakable and seamlessly integrated with the protected software, but also allow for the implementation of different software sales and licensing models. The solution should be non-disruptive when the software is in use, as well as during the programming stage when the software is created. In addition, the result of using the new method should not affect the performance of the running software, or make it not useful.

Some of the existing methods for protecting computer program usage are based on adding code to the computer program. For example, a software protection application may add an internal authorization mechanism that verifies the presence of a dongle or plug connected to a port of the computer. However, since the computer program is fully functional and capable of running properly without the added code, such protection methods may simply be bypassed by skipping over the added code.

A different approach, used in the prior art, includes a solution that splits the software that is being protected and puts a small portion of it onto a special non-breakable device. The unprotected part may be executed on the user hardware and therefore made publicly available; whereas, the protected part may be executed in a secure computing environment (“protected processor”) that is not publicly revealed in plain text form. The partition of the program may be chosen so that the protected part is difficult to reconstruct from the unprotected part of the program, or it is difficult to reverse-engineer. In addition, the partition may be designed so that in order for execution to succeed both parts of the computer program must be present during execution. This type of system was disclosed in ABYSS: An Architecture for Software Protection by White and Comerford, IEEE Transactions on Software Engineering, Vol 16, No. 6, June 1990. Finally, it should be noted that this invention neither limits the programming process nor the development stage.

The main limitation of the ABYSS system is that for security reasons, the protected part is located on a server in a remote computer that is connected via a network. The protected processor and the user hardware may communicate over the Internet or another network connection, which often puts communication ahead of performance and results in a noticeable delay whenever the protected part is accessed. This invention is therefore limited for use by only certain kinds of programs, based on a client-server structure or computer systems. It cannot be used in programs that require real-time performance, or in interactive programs such as user games. Furthermore, ABYSS authors neither disclosed a particular method for dividing a computer program to implement their security system, nor specified how to split monolithic software into a working client-server model.

Prior art that provides a method of partitioning a program, or the binary code of a program, and selecting parts of the code based on profiling information for its execution in a different computer or for compressing in order to save storage on small embedded systems, includes: (PCT WO 2006/120684 and Shlomit S. Pinter and Israel Waldman, “Selective Code Compression Scheme for Embedded Systems”, Transactions on HiPEAC—High-Performance Embedded Architectures and Compilers I, P. Stenström (Ed.); and LNCS 4050 Springer-Verlag Berlin Heidelberg, (February 2007) pp. 298-316), respectively.

There is a clear lack of a strong and performance-efficient solution for protecting the binary code of a program and the current invention addresses this need.

Other known protection mechanisms with a CD, dongle, or disk on key (data flash stick), namely solutions such as Approtec (PCT WO 2006120684 20061116), use a different approach from the current invention.

### SUMMARY OF THE INVENTION

The present invention relates to a system for limiting the execution of a software program only to an authorized user. The software program can be provided in any suitable software form, such as a binary code, or it can be written in a high level program language. In the present invention, the binary code of the program is analyzed by an analyzing software (e.g., software profiling data) and partitioned into parts, some of which are selected to be protected. The protected parts are selected so that during any execution of the software, at least some of the selected parts must be present and executed. The protected code is encrypted and at least partially saved (together with a decryption engine) on an attached secured computing device such as a secured disk on key with a small processor or controller, or a smart flash drive, such as USB Flash Drives, SSD (solid-state drive), HDD; and various different flash devices such as SD (secure digital) cards, etc. These computing devices should have a small processor or controller or co-processor and possibly some type of memory. Each encrypted part of the software (i.e., the selected parts) is replaced with a piece of software routine or code (alteration software) that calls the corresponding encrypted part (e.g., such as a Stub call).

Of course, the encrypted code portions can be stored on any device that includes memory, and not necessarily just in the secured computing device. For example, this may occur when the memory volume of the secured computing device is insufficient (i.e., relatively low) and cannot accommodate all the encrypted code portions. In such cases, during software runtime, each time the software gets to a Stub call, the corresponding encrypted code portion is transferred to the secured computing device, where the decryption engine (that operates within the secured area of the computing device) decrypts the code and provides the required data to the software in order to continue running properly.

The system of the present invention for limiting the execution of a software program only to an authorized user, comprises: a) computer hardware suitable to operate analyzing software and alteration software; b) analyzing software suitable to analyze said software program and to select one or more code portions of said software program; c) alteration software suitable to replace each of said selected code portions with a corresponding calling code; d) encryption engine for encrypting said selected code portions; e) a first storage device for storing at least a portion of said software program, wherein said stored software program is the non-encrypted parts of said software program containing said calling code; 0 a second storage device, having a secured area, wherein said second storage device is capable of securely executing a code within said secured area; g) a decryption engine capable of operating within said secured area for decrypting said encrypted code portions whenever requested; and h) an executer engine capable of operating within said secured area for performing the following tasks: i) providing data related to said decrypted code whenever requested by said calling code; ii) submitting said decrypted code to execution within said secured area when requested; and iii) using said decryption engine if need to decrypt a called code.

According to an embodiment of the invention, the code selected by the analyzing software is selected from a group consisting essentially of: sequences of register-only instructions, basic blocks, or parts of them, and whole function or subroutine. Optionally, the code selected by the analyzing software may not be the same for all users.

According to an embodiment of the invention, the first storage device is a portable storage device capable of being used by a computing device, or a remote storage unit (e.g., a remote server). According to an embodiment of the invention, the first storage device can be located in at least one of a group of devices such as a disk on key, a PDA, a smart flash drive, a cellular device, a video game console, a GPS device, a removable storage card, secure digital cards, and any combination thereof.

According to an embodiment of the invention, the second storage device can be a stand alone device or coupled with a computing device. Alternatively, the second storage device can be part of at least one of a group consisting of: USB flash drives, PDAs, smart flash drives, cellular devices, Solid State Drives (SSD), video game consoles, GPS devices, removable storage cards, secure digital cards, NAND flash cards, such as xD memory cards (e.g., xD-picture card), CompactFlash drives, and any combination thereof. The second storage device can be located in at least one of a group consisting of: a disk on key, a PDA, a smart flash drive, a cellular device, a video game console, a GPS device, a removable storage card, secure digital cards, and any combination thereof.

According to an embodiment of the invention, the decryption key for the encrypted selected code portions is stored in the secured area of the second storage device.

According to an embodiment of the invention, the encryption of the selected code portions is unique for each second storage device (i.e., each decryption engine is provided with a unique private key, thus each provided second storage device is unique).

According to an embodiment of the invention, at least a portion of the encrypted code portions can be stored in the first storage device, in the second storage device, or any combination thereof.

According to an embodiment of the invention, the calling code includes calling routine or Remote Procedure Call (RPC) software, or any known JMP method.

The present invention further relates to a computer implementation method for protecting a software program so that it can be executed only by an authorized user, said method comprises: a) analyzing said software s program and selecting one or more code portions thereof to be protected; b) replacing each of said selected code portions with a corresponding calling code; c) storing at least a portion of the code obtained in b) in a first storage device; d) encrypting said selected code portion(s); e) storing at least a portion of said encrypted selected code portions on a second storage device; f) providing a decryption engine capable of operating within a secured area for decrypting said encrypted code portions; and g) providing an executer engine capable of operating within a secured area for providing data related to said decrypted code whenever requested by said calling code, and for submitting code to execution within a secure area when requested, wherein said executer engine is capable of using decryption engine if need to decrypt called code.

According to an embodiment of the invention, the executer engine is invoked with a part of at least one of a group consisting of: calling routine, or remote procedure call, or any of known JMP method.

According to an embodiment of the invention, the computer implementation method comprises the steps of: 1) executing the protected software program stored in the first storage device, that is the non-encrypted portion of the software program comprising a calling code; 2) decrypting, with a decrypting engine, a called portion of said encrypted selected code if requested; and 3) executing in a secured area of a second storage device said decrypted called portion with related data when requested.

According to an embodiment of the invention, the computer implementation method comprises the steps of: 1) decrypting, with a decrypting engine, a portion of said encrypted selected code; 2) executing the protected software program stored in the first storage device, that is the non-encrypted portion of the software program comprising a calling code; and 3) executing a requested decrypted called portion with related data in a secured area of a second storage device, by an executer engine.

The present invention also relates to a computer implementation method for protecting software program so that it can be executed only by an authorized user, said computer implemented method comprises: a) analyzing said software program and selecting one or more code portions of said software program to be protected; b) replacing each of said selected code portions with a corresponding calling code; c) storing at least a portion of said protected software program in a first storage device; and d) storing at least a portion of said selected code portions in a secured area of a second storage device. This method further comprises: a) Executing the protected software program, stored in the first storage device, comprising a calling code; and b) Executing the called code with related data, if requested, within a secured area of a second storage device when requested. Executing the called code is invoked by a method part of at least one of a group consisting of: calling routine, or remote procedure call, or any of known JMP method.

### BRIEF DESCRIPTION OF THE DRAWINGS

Some embodiments of the invention herein described are to be used only by way of example as a reference to the accompanying drawings. With respect to the detailed drawings, it must be stressed that the particulars shown are for explanatory and illustrative purposes in order to only discuss the exemplary embodiments of the present invention. They are designed to aid in providing what is believed to be the most useful and readily understood description of the principles and conceptual aspects of the invention. In this sense, no attempt is made to show the structural details of the invention in more detail than is necessary to obtain a fundamental understanding of the invention, with the descriptions provided alongside the drawings meant to demonstrate how different forms of the invention may be embodied in practice.

In the drawings:

FIG. 1 schematically illustrates a secured system in accordance with prior art;

FIG. 2a illustrates a secured system in accordance with an embodiment of the present invention;

FIG. 2b illustrates a secured system in accordance with another embodiment of the present invention;

FIG. 3 illustrates a method for selecting portions of code to be encrypted in accordance with embodiments of the present invention; and

FIG. 4 illustrates a scheme for using the protected software at run time in accordance with embodiments of the present invention.

### DESCRIPTION OF EXEMPLARY EMBODIMENTS

The present invention describes systems and methods for protecting software so that it can only be executed by an authorized party. In this scheme, parts of the software are provided on non-protected media, and other parts are encrypted and at least partially reside on protected media that incorporates a protected computer processor. Examples of devices with such capabilities (i.e., protected media that incorporates a protected computer processor) include smart flash drives, mobile phone hardware, and software players. Each of these devices has a secured partition integrated into the hardware and is capable of executing code in a protected and timely manner.

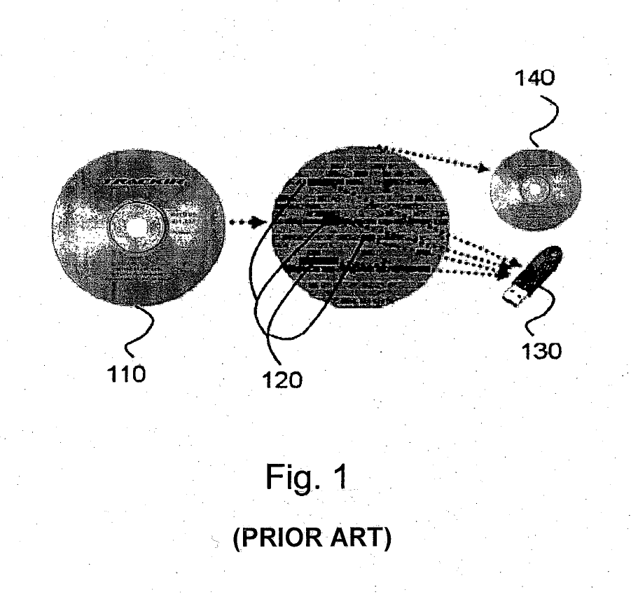

FIG. 1 illustrates a software protection scheme known in the art. Within the distributed software provided, on some type of memory 110, a Compact Disk (CD) in this example, segments of code 120 are protected by a private key that resides on dongle 130, or some other removable storage device. CD 140 holds the software with the protected segments and is distributed to users together with dongle 130 and the protected private key.

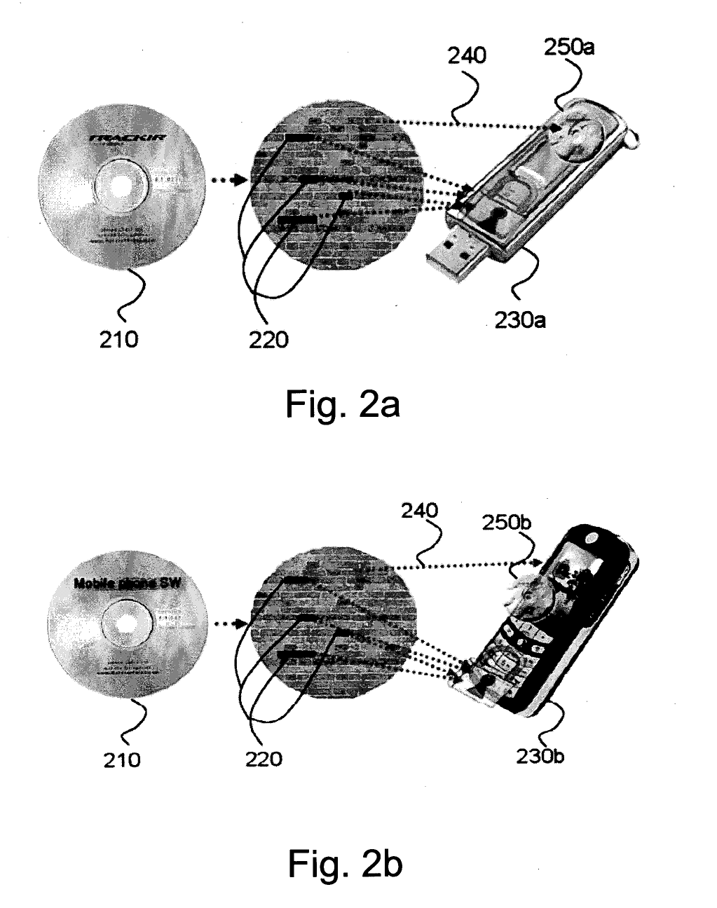

FIGS. 2a and 2b illustrate secured systems in accordance with some embodiments of the present invention. Within the sold software, provided on a type of memory 210, a CD in this example, segments of code 220 are encrypted and protected by a public key. Segments of code 220 are selected by any suitable partitioning method (e.g., by software based on profiling information) and are encrypted prior to software distribution. According to an embodiment of the present invention, upon software run time, parts of encrypted portions of code 220 are loaded on demand (when needed), decrypted, and executed on secured hardware (i.e., trusted zone). Thus, these portions of code are not accessible from non-protected areas and can only be instructed to execute when called at run time. In addition, the only permitted input and output (between the secured and non-secured areas) is passed through registers via a rigid interface. The selection process of code 220 is described and discussed later.

Of course, the encrypted portion of code 220 can be decrypted during different times and periods. For example, the encrypted portion of code 220 (or at least parts of the encrypted portions of code 220) can be decrypted prior to software run time in the trusted zone, thus the encrypted portions of code 220 are pre-loaded and decrypted in the trusted zone, and can be executed whenever required by the running software with minimal waiting time or delay.

In a first embodiment, encrypted segments of code 220 are stored in a protected part of a special disk on key 230a, which can execute code in a protected manner. Non-encrypted portions 240 of the distributed software are stored on non-protected storage 250a of the disk on key 230a.

In a second embodiment, encrypted segments of code 220 are stored in a protected part of cellular 230b, which can execute code in a protected manner. Non-encrypted portions 240 of the distributed software are stored in non-protected storage 250b of cellular 230b.

Optionally, non-protected code portions and encrypted codes are kept on other storage and computing devices such as PDAs, smart flash drives, video game consoles, GPS devices, and memory cards, such as, but not limited to, MMC/SDs, etc.

During execution of the software, the encrypted segments are called for execution by input data passed in the registers. Optionally, other means, such as secured memory, can be used to pass the input data to the protected portions.

Once an encrypted code is called, it is first decrypted and then executed in a protected area of device 230a or 230b for the first and second embodiments, respectively. When the execution of the encrypted segment is terminated, output data is passed to a non-protected area to continue execution of the software.

Preferably, the main goals of selecting specific portions of code to protect is to have representative portions of the code that must be executed in each run independent of the input data. However, the code must be selected so that the execution overhead introduced as a result of the need to decrypt those portions of code at run time (or prior to run time in several embodiments) and run them on a trusted entity is bounded as desired. Furthermore, in order to avoid bypass of the code selected for encryption, and to make it safe against changes by a third party, the selected code must be such a code, or located in such a place within the software, that it will be relatively difficult to create an alternative code for it, or for it to be bypassed (i.e., the code should be non-trivial and located in a non-trivial location). For example, in the case of software that represents a game, such as a sports game, and the sports game is provided with an “Intro” that runs at the beginning of the software run time (i.e., before the first level of the to game), the portion of code for encryption should not be selected from the

“Intro” location, as a third party may bypass the “Intro” and will still be able to play the sports game (without the “Intro”).

According to an embodiment of the invention, the encryption of the selected code portions is unique for each user. Each decryption engine (i.e., client) is provided with a unique decryption key (i.e., private key). As the decryption engine is kept in a secured area (i.e., trusted zone) the user has no access to the private key (i.e., like an airplane “black box”). Therefore, the encrypted code portion can be located anywhere; it can even be downloaded from a remote server (e.g., via an Internet connection). However, the decryption can only be executed in the trusted zone while using a unique decryption key which corresponds to a specific encryption.

An executer engine capable of operating within the trusted zone can be used for executing the selected secured code. At run time of the protected software, its goal is to ensure that the selected secured code that is called (needs to be executed) is actually executing. Thus, the executer engine is capable of using a decryption engine, if there is a need to decrypt a called code (i.e., if it is still encrypted), provides input data related to the called code, whenever requested by the calling code, and submits data to be executed by the computing entity within the trusted secured area when requested.

The executer engine code can be invoked by many known methods such as calling routine or Remote Procedure Call (RPC) software, or one of any known JMP method. The complexity and size of the executer engine can vary depending on the trusted device containing the secured area. It can be implemented with a simple table that stores the secured code (directly or with some pointing code such as an address, offset, pointer, etc.), or it can be more complex implemented with a small code (e.g., client code) that manges the execution. Other implementations for executing remote code are possible as well.

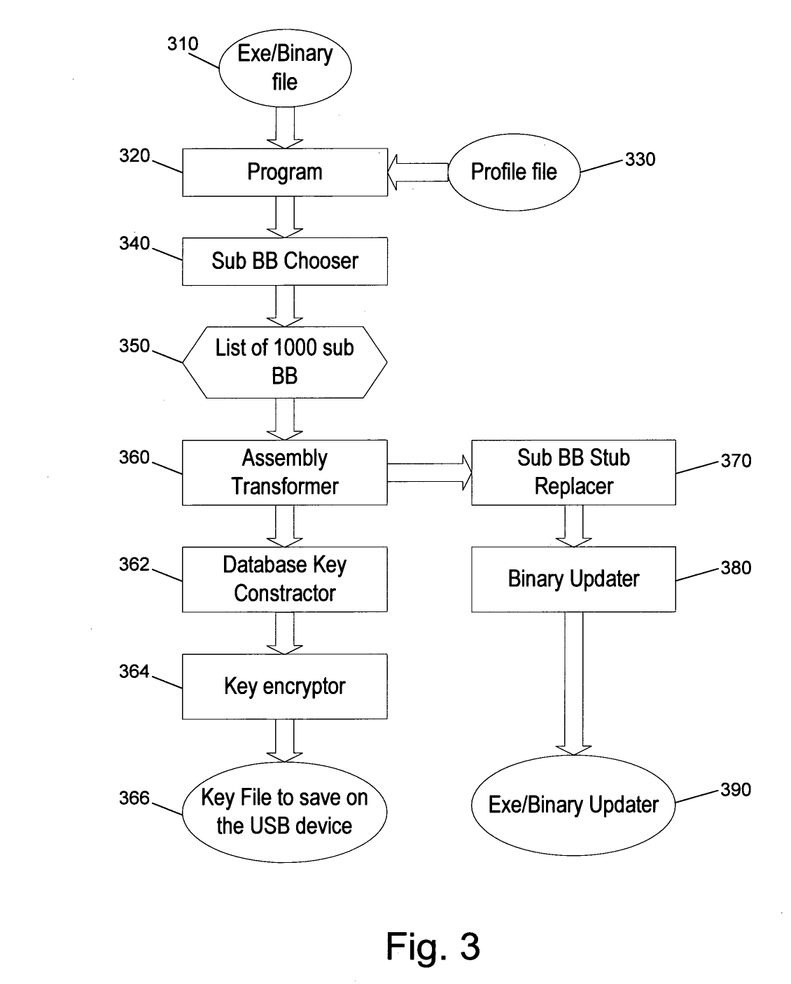

Reference is now made to FIG. 3, which illustrates, in flow chart form, a method for selecting portions of code to encrypt in accordance with embodiments of the present invention. The input program/software is provided as an executed file (e.g., “.exe”) or binary file (block 310). The file is analyzed by a reverse engineering method known in the art (e.g. FDPR, different dis-assemblers and debuggers), and the software is presented with its Basic Block (BB), structure (block 320). Alternatively, the software manufacturer may provide the software in its Basic Block form.

Based on profiling results that combine data from multiple characteristic runs, e.g., of a profiler (block 330), or by any other partitioning method known in the art, portions of the code, such as a set of Basic Blocks (BB) or parts of them, are selected to be secured on the protected hardware partition, e.g., by subroutine BB chooser (block 340). Optionally, the selected code portions can include only sequences of register-only instructions. Alternatively, the selected code portions can include a whole function or subroutine.

The selected parts may be presented, (block 350), in any way known in the art, such as, by the entry code addresses or with a list of instructions. In FIG. 3 in this embodiment, at most 1000 basic block are listed. The code selected, based on the profiler output, may include “warm” addresses, or addresses that are visited often on the train runs without causing excessive performance degradation, yet may not be easily bypassed. The selection of code portions to be extracted for encryption is carried out by software means that was created by developers unfamiliar with the original code or by the content developers. It is desirable that the selected code will operate only on registers (i.e., preferably, all of the instructions in the selected code do not address memory).

The input binary code, together with pointers to the code selected for encryption, are transferred to an alteration software, such as an assembly transformer (block 360) to split the code, removing the selected code for encryption, and inserting calling codes (e.g., Stub calls) instead of the selected code portions that were removed. According to an embodiment of the invention, the calling code generated by the alteration software includes calling routine or Remote Procedure Call (RPC) software, or one of any known JMP method. For example, code for the Stubs are built and inserted by components such as Subroutine BB Stub Replacer (block 370) and Binary Updater (block 380).

According to an embodiment of the invention, the generated modified code with the Stubs (block 390) is the same for all prospective customers. Of course, in some cases, different or partially different BBs of the same software may be selected, thus the generated modified code with the Stubs will not be the same for all prospective customers.

The selected code portions for encryption can be provided in a database or a file indexed by key and data, where the key is the starting address of a code fragment, and the data is a sequence of machine instructions, or any other storage means and types known in the art. Optionally, for further security, different lists of selected code portions can be selected for each customer.

Upon customer request to use or buy a software, which may reside on a server at the producer, distributor, or another entity; or optionally, prior to initial distribution to a customer, the selected code portions in the database are encrypted with a public key, such as by a Database Key Constructor (block 362) and a Key encryptor (block 364). For example, the selected code portions in the database are encrypted with the public key of the customer's trusted device or with the public key of a secure dongle. The results of the encryption process (block 366) are passed to protected areas in the user protected device such as device 230a or 230b (FIGS. 2a and 2b). Optionally, the encrypted data can be stored on any storage device. Alternatively, the user can buy a dongle or other hardware that can protect and run on a secured device that uses non-accessible internal SSL secured memory on which the encrypted code will be stored.

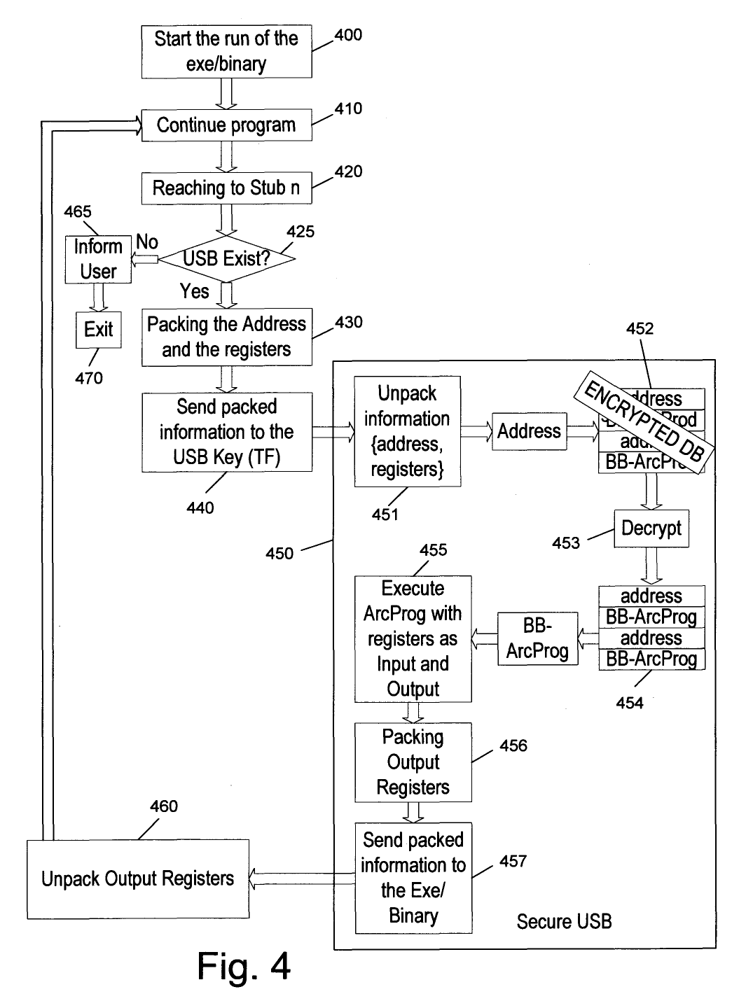

Reference is now made to FIG. 4, which illustrates a scheme for using the protected software at run time in accordance with embodiments of the present invention. A run of the software is initialized (block 400); the execution of the software continues (block 410) until a Stub call is reached (block 420). If a protected device with the removed code exists (block 425), and the end of the program is not yet reached, the relevant code portion is selected from the database (e.g., by packing data such as the address and the value of the registers according to the current code line of the software run, (block 430) and moving the packed data, (block 440) to be executed in a secured partition of a secured computing device (e.g., secure USB flash memory drive, block 450) together with the desired arguments. The results of the execution in the secured computing. device (e.g., the unpacked output registers) are passed to the non-encrypted part of the code (block 460) to continue execution of the software (block 410). This execution pattern continues until the end of the run is reached (block 470). The end of the run also occurs when the protected device does not exist and the software run reaches a Stub call. Optionally, the user may be informed (block 465) before the end of the run.

According to an embodiment of the invention, the decryption key for the encrypted selected code portions is stored in the secured area of the secured computing device. For example, the execution of the received packed data in the secured computing device (block 450) may execute as follows: At first, block 451, the data is unpacked (e.g., providing address and registers). In the next step, block 452, the provided unpacked address point on the location of the required code portion is stored in the encrypted database. In the next step, block 453, the required code portion is decrypted thereby providing the original non-encrypted code portion, e.g., BB-ArcProg (block 454). In the next step, block 455, the original code portion is executed with the registers (from the unpacked data) as input and output registers. In the next step, block 456, the output registers are packed. In the next step, block 457, the packed data is moved (outside of the secured computing device) to the running software (block 460).

It should be clear that the description of the embodiments and attached figures set forth in this specification serves only to provide a better understanding of the invention, without limiting its scope as covered by the following claims.

It should also be noted that a person skilled in the art, after reading the present specification can make adjustments or amendments to the attached figures and the above described embodiments that would still be covered by the following claims.

1-20. (canceled)

21. A method for limiting the execution of a software program only to an authorized user, comprising:
A. a preparation stage comprising:
a) providing a software program to be protected against unauthorized use;
b) analyzing said software program and presenting its basic blocks of code;
c) selecting at least a portion of said basic blocks to be protected;
d) preparing an unprotected part of said software program by:
i) removing said selected portion of said basic blocks and inserting a calling code instead of each of said removed basic blocks; and
ii) storing said prepared unprotected part of said software program in a on a non-secured storage device; and
e) storing said removed portion in a protected area; and
B. executing said software program, comprising:
a) providing a non-secured device having said non-protected storage and a non-secured processor, capable of communicating with said protected area, wherein said protected area comprises a storage for said removed portion of said basic blocks and a secured processor;
b) executing said unprotected part of said software program on said non-secured processor;
c) reaching one of said inserted calling code replacing the corresponding removed portion of basic block;
d) submitting to said protected area data needed for executing said corresponding removed portion of basic block, within said protected area;
e) executing said corresponding removed basic block in said protected area, and returning result of said executing to the place of said calling code in said unprotected part of said software program; and
f) continuing execution of said unprotected part of said software program on said non-secured processor until one of:
i) reaching another one of said inserted calling code; or one of said inserted calling code; or
ii) terminating of said execution of said software program if said protected area is unavailable.

22. The method of claim 21, wherein said executing said corresponding removed basic block in said protected area is implemented with a table that stores the secured code.

23. The method of claim 22, wherein said executing said table further comprises pointing code selected from the group consisting of: address, offset, pointer, and combinations thereof

24. The method of claim 21, wherein said software program to be protected is provided as an executable file, and said analyzing of said software program further comprises using software for reverse engineering to present structure of said basic blocks of said software program to be protected.

25. The method of claim 21, wherein said selecting a portion of said basic blocks to be protected further comprises using a basic block choosing subroutine.

26. The method of claim 21, wherein at least one of said removed portion is comprises sequences of register-only instructions.

27. The method of claim 26, wherein said protected area is in a remote server.

28. The method of claim 21, wherein at least one of said removed portion comprises blocks selected from the group consisting of complete basic blocks and partial basic blocks.

29. The method of claim 21, wherein at least one of said removed portion comprises blocks selected from the group consisting of whole functions and subroutines.

30. The method of claim 21, wherein said selecting a portion of said basic blocks to be protected comprises selecting at least a portion of said basic blocks that:
must be executed when said program is executed; and
causes minimal delay.

31. The method of claim 21, wherein said protected area is a secured hardware within the non-secured device executing said software program.

32. The method of claim 21, wherein said protected area is the protected part of a special disk on key, which can execute code in a protected manner.

33. The method of claim 21, wherein said protected area is the protected part of a cellular.

34. The method of claim 33, wherein said protected area is the protected part of a cellular, which can execute code in a protected manner, while the said prepared unprotected part of said software program is stored in the non-protected storage of said cellular.

35. The method of claim 21, wherein:
said protected area further comprises a decryption engine;
said storing of said removed portion further comprises encrypting said removed portion; and
said executing of said removed portion further comprises decrypting said encrypted stored removed portion by said decryption engine.

36. The method of claim 35, wherein the decryption key for said decryption engine is unique.

37. The method of claim 36, wherein at least one of said encrypted selected portion of said removed portion of basic blocks is stored in a non-protected storage.

38. The method of claim 35, wherein at least one of the encrypted portions of code is decrypted prior to execution of said software in the trusted zone.

39. The method of claim 35, further comprising:
a) said submitting to said protected area data to be executed within said protected area comprising:
packing data such as the address and the value of the registers according to the current code line of the software run; and
moving the packed data to be executed in a secured partition of a secured computing device together with the desired arguments;
b) said executing said removed basic block in said protected area comprising:
unpacking said packed data thus providing address and registers;
using said unpacked address to point on the location of the required code portion stored in the encrypted database;
decrypting required code portion, thereby providing the original non-encrypted removed code portion BB-ArcProg;
executing said original code portion with said unpacked registers as input and output registers;
packing said output registers to create packed data; and
moving said packed data is moved outside of the secured area; and
c) said continuing execution of said unprotected part of said software program on said non-secured device comprising:
unpacking the results of the execution in the secured area passed to the non-encrypted part of the code; and
using said unpacked results to continue execution of the software.

40. The method of claim 21, wherein said submitting data to said protected area comprises using secured memory.
